(19) United States
(12) Patent Application Publication
(10) Pub. No.: US 2008/0153076 A1
(43) Pub. Date: Jun. 26, 2008

(54) MEDICAL CONDITION EDUCATION AND START-UP KIT

(75) Inventors: Edward L. Schlueter, Rochester, NY (US); Louis Reale, Rochester, NY (US)

Correspondence Address: JAECKLE FLEISCHMANN & MUGEL, LLP, 190 Linden Oaks, ROCHESTER, NY, 14625-2812, US

(73) Assignee: MED GRAPH, INC.

(21) Appl. No.: 11/615,471

(22) Filed: Dec. 22, 2006

(51) Int. Cl. G09B 19/00

(52) U.S. Cl. 434/262; 206/569

(57) ABSTRACT

A medical kit for educating a patient is disclosed. The medical kit includes at least one education tool related to at least one medical condition and designed to help the patient become a seasoned patient in regard to the medical condition. The medical kit also includes at least one health object which can be used by the patient. The medical kit further includes instructions for using the at least one health object.

### FIELD

The claimed invention relates to patient managed care for a medical condition and education of the patient pertaining to the medical condition. More particularly, the claimed invention relates to start-up kits which enable patient managed care for various medical conditions while focusing on education of the patient.

### BACKGROUND

The concept of a medical kit is varied. In its simplest form, a medical kit is simply a collection of medical supplies, from a simple first aid kit which may have a series of bandages, ointments, and pills within a plastic case, to more elaborate medicine chests or field kits intended to be used by medical professionals. Some of these collections of medical supplies have received past patent protection. For example, U.S. Pat. No. 4,169,550 discloses an emergency medical kit, in the form of a rucksack, which has pockets and straps for medical equipment, and which can be either worn on the back, used on a table, or suspended from a hook. U.S. Pat. No. 4,212,392 discloses a medical emergency treatment kit, in the form of a cabinet, which secures medicines, instruments, and equipment in an easily accessible manner within a solid upright housing. U.S. Pat. No. 6,116,426 discloses an emergency medical kit having a compartmentized container for use in organizing and protecting eye-related instruments and supplies such as sterilized pads, drugs, extractors, lights, ointments, tape, and other items needed by physicians or emergency personnel. Such general-use medical kits are useful, but primarily serve as portable organization devices for medical supplies and as such, they tend to rely on the knowledge of the user to understand a medical condition, what supplies to choose, and how to use them. This can limit the use of such medical kits to those with specialized knowledge, such as doctors, nurses, or paramedics, or it can limit the use of such medical kits to simple medical conditions such as small cuts and bruises.

In order to allow people without specialized knowledge to make use of the supplies within a medical kit, other types of medical kits may also include instructions on how to use the supplies within the kit. For example, U.S. Pat. No. 5,848,700 discloses an emergency medical care kit with medical emergency instructions. The kit is in the form of a briefcase with upper and lower sections which are divided into many compartments by a plastic organizer. Each of the compartments are labeled for a type of medical emergency, while the reverse side of each compartment lid has instructions for the treatment of the emergency. The necessary care items are in the compartment. U.S. Pat. No. 5,544,753 discloses a kit for the care of back ailments which is designed to be given to the patient by either a caregiver or other outlet, such as a retail establishment or clinic, and allows the user to treat the most common forms of back discomfort that arise. The disclosed kit also includes an instruction video tape and a written manual to instruct the user as to the proper use of the included massage ointments, support devices, ice packs, and dietary supplements. Regardless of whether or not the medical kit is for general first aid, or something specific, such as a back ailment, medical kits exist which contain instructions on the use of supplies contained within the medical kit.

Some medical kits not only contain instructions for the patient on how to use the supplies contained therein, but also are organized into a system of multiple kits which allow a physician to quickly select and prescribe an appropriate treatment kit for a desired duration between professional visits. U.S. Patent Application 2004/0167805 discloses a medical pack that can include a set number of medications and other medical supplies, the amounts of which are selected for a specific period of home treatment. The medical packs can also include instructions using photographs or other media and a patient log. The medical packs are organized according to various medical conditions to assist the doctor in choosing the correct medical treatment pack. The packs may include marketing materials, and are organized so that a patient may bring the pack back to a doctor for a follow-up visit thereby allowing the doctor to evaluate the patient's compliance with his treatment instructions. Such medical kits give the doctor a way to see if a patient is using the prescribed medical supplies by seeing if there are unused medical supplies in the medical kit during the follow-up visit, and by reviewing the patient's entries in the log-book. Therefore, over multiple visits, the doctor can assess whether or not the patient is properly using the supplies in the medical kit.

Further types of medical kits also exist to serve people who are already seasoned users of medical supplies. Such kits may or may not come with instructions on how to use the supplies. Some of these types of medical kits may not even come with supplies, but can provide a fashionable or helpful organization system for the carrying of necessary medical supplies as provisioned by the user of the kit. Examples include U.S. Pat. No. 6,959,814 which discloses a portable insulin caddy for storing an insulin pen or syringe, sterilization supplies, and needles. The kit is foldable with hook and loop closures. U.S. Pat. No. 7,093,595 discloses a portable medication kit which contains the materials necessary for a user to deliver inhalable medicine. A dosing guidance area is also included in the kit, where the user can make notes about the medicines which they have to take. These types of medical kits assist people with medical conditions by providing convenience and/or style in carrying or organizing their medical supplies.

As illustrated by the above types of medical kits, it is clear that the art is replete with examples of medical kits which are equipped or may be equipped with medical supplies for the treatment of a given medical condition. What is lacking is a medical kit focused on education of patients with a newly diagnosed medical condition as to what their condition really is, how it may affect their life, and how they can take preventative actions to improve their quality of life.

### SUMMARY

A medical kit for educating a patient is disclosed. The medical kit includes at least one education tool related to at least one medical condition and designed to help the patient become a seasoned patient in regard to the medical condition. The medical kit also includes at least one health object which can be used by the patient. The medical kit further includes instructions for using the at least one health object.

A method for increasing a patient's chances of successfully regulating a medical condition is disclosed. It is established that the patient is at high risk for or has the medical condition. The patient is provided with a medical kit for educating the patient in regards to the medical condition. The medical kit has at least one education tool related to the medical condition and designed to help the patient become a seasoned patient in regard to the medical condition. The medical kit also has at least one health object which can be used by the patient. The medical kit further has instructions for using the at least one health object. The at least one education tool, the health object, and the instructions are used by the patient to assist the patient in becoming a seasoned patient.

A system for increasing a patient's chances of successfully regulating a medical condition is disclosed. The system includes a medical kit for educating the patient in regard to the medical condition. The medical kit has at least one education tool related to the medical condition and designed to help the patient become a seasoned patient in regard to the medical condition. The medical kit also has at least one health object which can be used by the patient to collect data about the patient and which is configured to communicate with a network. The medical kit further has instructions for using the at least one health object. The system also has a remote processor which is coupled to the network. The system further has a remote storage device coupled to the remote processor. The at least one health object may communicate data about the patient relative to the medical condition over the network to the remote processor for storage in the remote storage device.

### BRIEF DESCRIPTION OF THE DRAWINGS

FIG. 1 schematically illustrates a patient with a diagnosed medical condition, and his options for information related to the medical condition.

FIG. 2 schematically illustrates two learning curves which demonstrate embodiments of a patient's chances of successfully regulating a medical condition over time.

FIG. 3 illustrates one embodiment of actions which can be taken to increase a patient's chances of successfully regulating a medical condition.

FIG. 4 schematically illustrates one embodiment of a medical kit for educating a patient.

FIG. 5 schematically illustrates several embodiments of education tools which can make up a part of various embodiments of medical kits.

FIGS. 6A and 6B schematically illustrates several embodiments of health objects which can make up a part of various embodiments of medical kits.

FIG. 7 schematically illustrates another embodiment of a medical kit for educating a patient.

FIG. 8 schematically illustrates one embodiment of a diabetic introductory medical kit.

FIG. 9 schematically illustrates one embodiment of a system for increasing a patient's chances of successfully regulating a medical condition.

It will be appreciated that for purposes of clarity and where deemed appropriate, reference numerals have been repeated in the figures to indicate corresponding features, and that the various elements in the drawings have not necessarily been drawn to scale in order to better show the features of the invention.

### DETAILED DESCRIPTION

When patients are diagnosed with certain medical conditions, it can be a traumatic and life-changing experience that is often best calmed by education and compassion. Unfortunately, there are increasingly fewer physicians and nurses to care for a larger and larger number of patients due in part to many factors such as longer life expectancy, the maturation of the baby-boom generation, and our increasing ability to screen-for and identify medical conditions. This has contributed to a shifting trend from hospitalized care to patient managed care. In order to facilitate this shift to patient managed care, however, improvements in patient education regarding their medical conditions is needed, and in many cases, this improvement in patient education also needs to be coupled with improved diagnostic communications from the patient to their medical professional so that the caregiver can have the ability to efficiently monitor the patient's status.

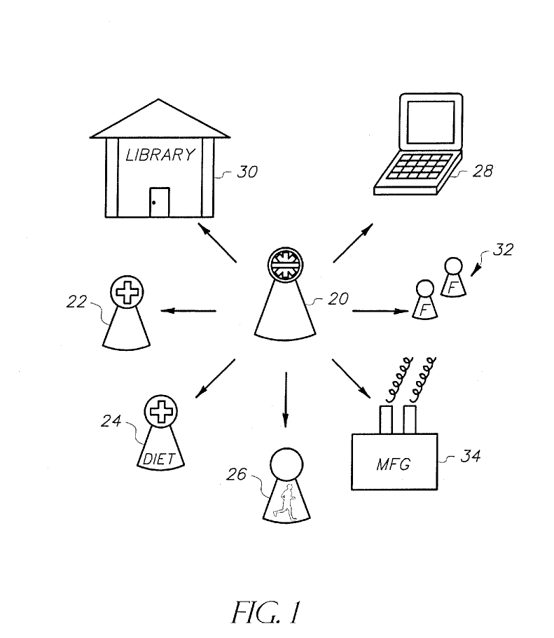

FIG. 1 schematically illustrates a patient 20 with a diagnosed medical condition. Especially for the newly diagnosed patient 20, when they are first told that they have the medical condition, it can be shocking. For example, in the case of a patient 20 who has found out they have diabetes, the patient 20 can be stressed and confused in part due to the multifaceted approach suggested to control diabetes and the associated learning curve involved with blood glucose management. Areas to gain competence in include, but are not limited to: blood glucose level monitoring, what equipment to use, monitored data collection, communications with health care professionals, diet, exercise, educating family, friends, and co-workers, trend analysis and recognition, emergency precautions and procedures, etc. Depending on the age, attitude, mental/emotional and physical condition of the newly diagnosed diabetic patient 20, certain aspects of the control regime may require extra attention. For example, diabetics in the teenage years may have to emphasize diet control, while those in the older age groups may need to focus more in the area of exercise. It should be understood that diabetes is just one example of a medical condition which can be shocking to a patient 20 and/or call for lifestyle changes.

Currently, the patient 20 has to go in many directions to gather the necessary information about his medical condition. Consultations with physicians 22 are a starting point, but can be very expensive, and are often limited in duration due to the overloaded nature of physicians 22 these days. The busy schedules of many physicians 22 can also lead to long periods of time, even months at a time, between visits with the physician 22. Ideally, the patient 20 will not only want to talk to a physician 22, he may also wish to consult a dietary professional 24 and an exercise professional 26. These other types of professionals and specialists may also have busy schedules and consultations with them will dramatically increase the expenditures by the patient 20.

Given the time and expense involved in these types of consultations, many patients 20 will do some of their own research. Many will consult electronic sources 28 such as the internet. The internet has a plethora of information, but this information can be overwhelming. For example, the newly diagnosed diabetic who types “diabetes” into a leading search engine can come back with over eighty-nine million hits. Through trial and error this search string can be whittled down to the hundreds or thousands of hits, but then the patient 20 is still faced with deciding which electronic references are worthwhile. It is not uncommon to find conflicting opinions and information where some medical conditions are concerned. A patient 20 in this situation can have a tough time finding out which information applies to them, and any success a patient 20 has consulting electronic sources 28 is predicated upon the fact that they must have access to such sources in the first place, and on their skill using the electronic sources 28. Unfortunately, many medical conditions, such as for example, diabetes afflict a large percentage of people having lesser financial means and experience with computers, so these options may not even be available to them.

Many patients 20 will turn to one or more libraries 30 in the hopes of learning more about their medical condition. Unfortunately, access to medical libraries 30 is often restricted to physicians and medical students, and public libraries 30 often have out of date or very generic books on medical conditions. A search of texts in a library 30 may also leave the patient 20 confused with differing opinions from different books and not knowing which advice he reads applies to him.

Many patients 20 will instinctively look to other people 32 for advice on their medical condition. Finding a support group or a discussion group on the internet can be hit or miss, and there is not a high likelihood of success. Other people 32 are more likely to provide emotional support, which, though important, does not supplant a lack of sound medical advice.

Finally, while many patients 20 struggle over time to come to a helpful understanding of their medical conditions, they will often turn to products from various manufacturers 34 to help with the treatment of their medical condition. A patient 20 can be overwhelmed at this point by the number of treatment offerings. For example, in relation to diabetes, there can be dozens of glucose testing units available online or in stores from various manufacturers 34. The overwhelming choice can lead to no choice at all by a patient 20, or it can lead to a choice of a treatment offering which is not based on any reasoning which would be medically pertinent to the patient 20.

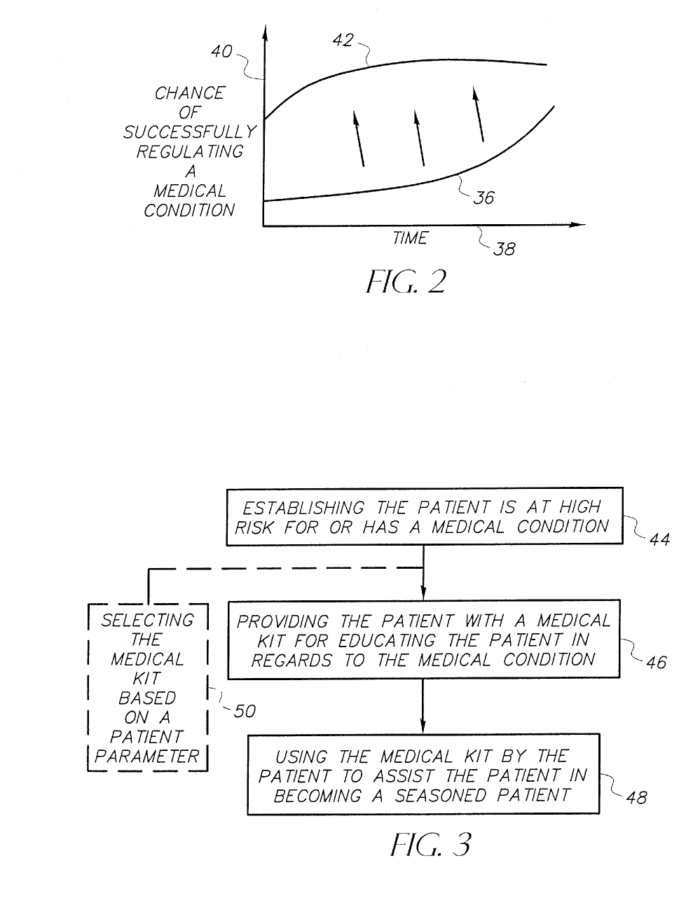

As FIG. 2 schematically illustrates, the patient 20 faced with the real-world choices at their disposal to educate themselves about a medical condition they have been diagnosed with faces a long learning curve 36 whereby it can take them a relatively long time 38 to obtain the knowledge necessary to increase his chance 40 of successfully regulating the medical condition. This is exacerbated as more and more healthcare shifts to the home. The claimed invention offers a medical lit, method, and system which may shift the long learning curve 36 to an accelerated learning curve 42 whereby a patient 20 can increase his chance 40 of successfully regulating the medical condition in a shorter time 38. This helps patients 20 who have been newly diagnosed with a medical condition to quickly become seasoned patients who stand a better chance of managing their medical condition. It can also help people who are not newly diagnosed, but who are still at a low point on the learning curve.

FIG. 3 illustrates one embodiment of actions which can be taken to increase a patient's chances of successfully regulating a medical condition. First, it is established 44 that the patient is at high risk for a particular medical condition. Examples of possible medical conditions the patient may be diagnosed with include, but are not limited to diabetes, high blood pressure, heart disease, abnormal pulse, abnormal weight, asthma, pregnancy, need for oxygen (such as emphysema), lung disease, stroke, influenza, pneumonia, kidney disease, liver disease, skin disease, allergies, eye conditions, thyroid disease, muscular disease, cancer, lupus, and arthritis.

One of the overall goals is to increase the chance of successfully regulating the medical condition, and allowing the patient to do that in a reduced time. Preventing the medical condition from occurring would fall under regulating the medical condition, so the actions described herein apply equally as well to patients who are established 44 to be at high risk for a medical condition as they do to patients who are established 44 to have the medical condition.

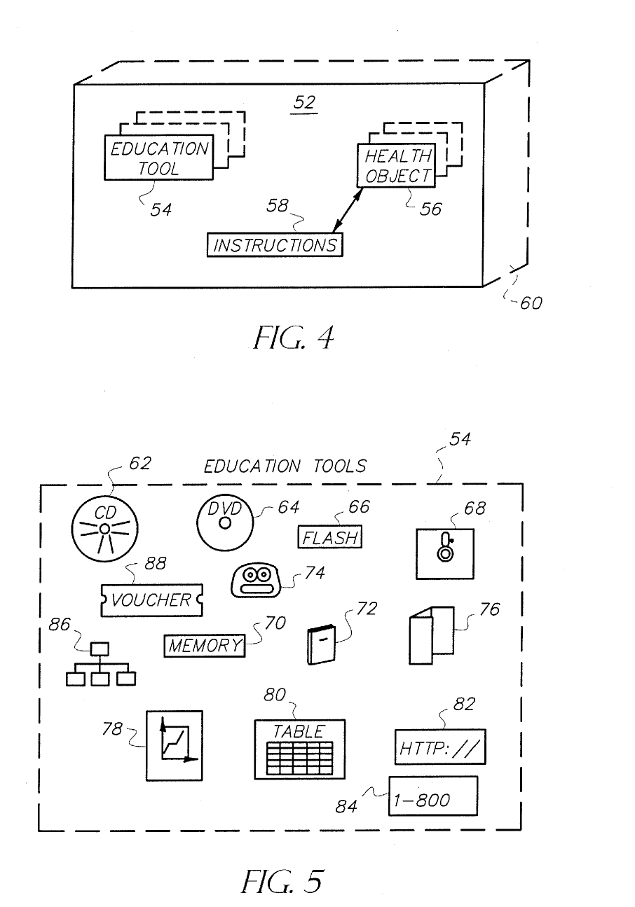

The patient is then provided 46 with a medical kit for educating the patient in regards to the medical condition. The medical kit has at least one education tool related to the medical condition and designed to help the patient become a seasoned patient in regard to the medical condition. The medical kit also has at least one health object which can be used by the patient. The medical kit further has instructions for using the at least one health object. The components of the medical kit, including the at least one education tool, the at least one health object, and the instructions will be discussed in more detail below with regard to FIGS. 4-8. The medical kit is used 48 by the patient to assist the patient in becoming a seasoned patient.

In some embodiments, the medical kit is selected 50 based on one or more patient parameters. Examples of patient parameters include but are not limited to the patient's age, the health of the patient, the habits of the patient, the education level of the patient, the computer skills of the patient, whether or not the patient has access to a phone line, and/or whether or not the patient has access to the internet. For example, in the case where a patient is young, the medical kit selected may be configured to cater to young children, for example by having simple-to-use technology for the health object(s) in the kit, exciting packaging, separate instructions for the child and their parents, and/or education tools which are age appropriate. A patient of poor general health may have a kit selected for their medical condition which focuses on the basic parameters related to the medical condition which should be within their control. For example, someone of limited mobility who has been diagnosed with diabetes would not be given a kit containing materials on ideas to increase exercise by walking or running. Although this can be good advice for diabetics, it would not be helpful to someone with a limited mobility health concern. A patient who is in the habit of smoking regularly might receive a medical kit for their medical condition which contains more information on the benefits of quitting smoking as they pertain to the regulation of the medical condition. Someone who does not smoke would not need this type of information in their medical kit. Someone with a high-level education might be given a medical kit which goes into great detail on the causes and regulation of their medical condition, because such level of information might be satisfying to them and allow them to have all the information they desire. Someone with a lower level of education or intelligence might not care so much about the underlying causes of their medical condition, and could be given a medical kit which was focused on the next steps so they could more quickly increase their chance of successfully regulating the condition. Different types of health objects can be included in different medical kits based upon the patient's environment at home. For example, if the patient has a phone line, then they could be given a kit with a health object which communicates over the phone line. Similarly, if a patient had internet access, they could be given a health object which communicates over the internet. Patient parameters could also include what type of computer a patient has (if any), such as a PC or a Mac®, what type of operating system they are using, such as Windowsφ, OS10®, or Linux®. Many other patient parameters can be used to customize medical kits, and will be apparent to those of skill in the art. Such other patient parameters and their equivalents are intended to be included within the scope of the appended claims.

FIG. 4 schematically illustrates an embodiment of a medical kit 52 which may be used for educating patients as referred to above. The medical kit 52 has at least one education tool 54 related to at least one medical condition and designed to help the patient become a seasoned patient in regard to the medical condition. The seasoned patient needs less assistance from medical professionals, has minimal needs to search for information regarding their medical condition, and when they do need to obtain information relative to their medical condition, they know where to find the information. The medical kit 52 also has at least one health object 56 which can be used by the patient. The health object 56 assists the patient in regulating the medical condition. It should be noted that in some embodiments, regulation of the medical condition can also include prevention of the medical condition. The medical kit 52 further includes instructions 58 for using the at least one health object 56. Some embodiments of the medical kit 52 may have a carrying case 60 which houses the medical kit 52.

FIG. 5 schematically illustrates various types of education tools 54 which may be found in embodiments of the medical kit 52. The at least one education tool 54 can comprise information material related to the at least one medical condition. The information material of the education tool 54 can include many different delivery mechanisms, which for example can include a compact disc (CD) 62, DVD 64, a flash drive 66, a disk 68, a computer readable memory 70, a book 72, a cassette 74, a pamphlet 76, a chart 78, a table 80, a web address 82, a telecommunications number 84, a recommended organization 86, or even a voucher 88 for a training service or class.

Regardless of the manner of delivery of the education tools 54, the education tools 54 can cover many topics of interest to the patient, including, but not limited to exercise information; dietary information; information on how to communicate with a health care professional; information on educating and communicating with family, friends, and/or co-workers of the patient; information material on recognizing and/or analyzing trends related to the medical condition, information material on emergency precautions and procedures.

There are numerous advantages already outlined for the patient who is provided with the medical kit 52 having the at least one education tool 54, and preferably multiple education tools 54. There are also advantages to the physician or other provider of the medical kit 52 because they can efficiently give the patient the tools which are appropriate for their medical condition and patient parameters and have confidence that the kit 52 has been put together, preferably, as a practical and effective package which has been tested and which uses state of the art technology.

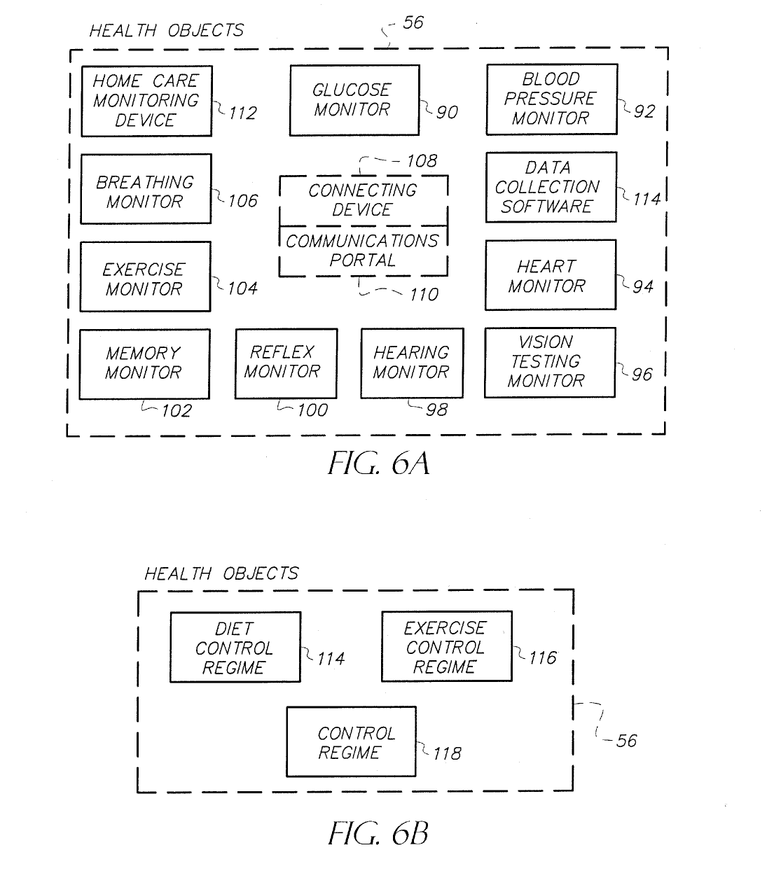

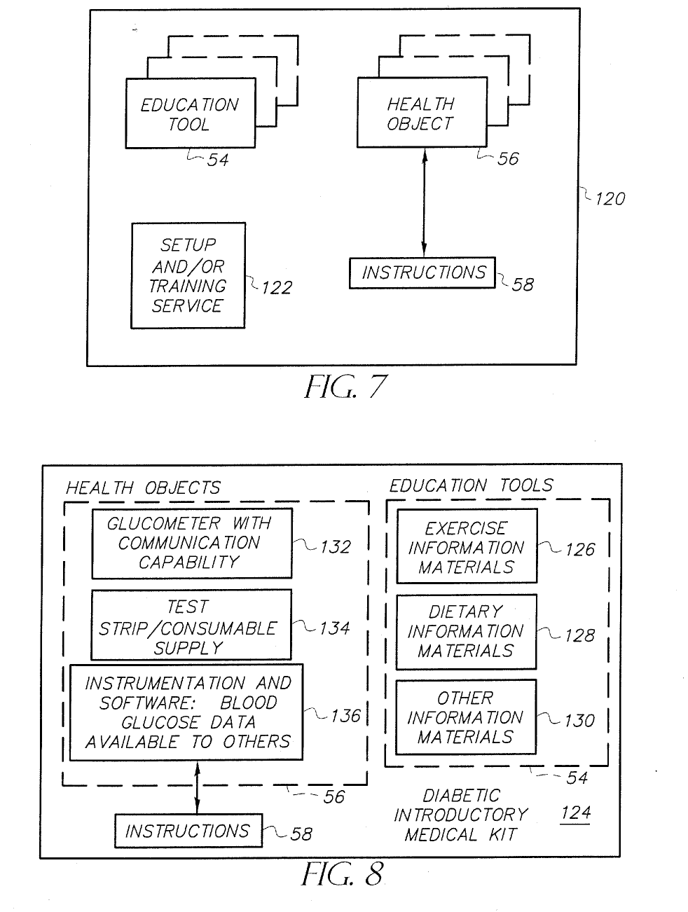

The technology present in the medical kit may take the form of the at least one health object 56. FIG. 6A schematically illustrates several embodiments of health objects 56 which may be included in a medical kit 52. The at least one health object 56 is preferably related to the medical condition and can be used by the patient. Depending on the embodiment of the medical kit 52, and the medical condition it is designed for, some examples of the at least one health object 56 include, but are not limited to a glucose monitor 90, a blood pressure monitor 92, a heart monitor 94, a vision testing monitor 96, a hearing monitor 98, a reflex monitor 100, a memory monitor 102, an exercise monitor 104, a breathing monitor 106, or any combination thereof.

Glucose monitors 90 are known to those skilled in the art, and there are many choices that need to be sorted through for the patient when putting together a medical kit 52. A medical kit 52 for diabetics would benefit the patient by selecting for them a recommended glucose monitor. There are many styles of glucose monitors, those which collect readings, but do not store the readings, those which can store a history of readings, and those which include a connecting device 108 for communicating through a communications portal 110 so that data may be sent to or retrieved by an external device. The other types of health objects 56 may also have connecting devices 108 such as cables, infrared transmitters, and wireless transmitters which allow communications through a communication portal 110.

Blood pressure monitors 92 are well known in the art, and typically include a pressure cuff which can be manually or automatically inflated. Heart monitors 94 can be something as simple as a watch which measures the patient's heart rate to something more complex such as a pacemaker interface which displays data collected from an embedded pacemaker or its embedded sensor leads. A vision testing monitor 96 can be a software program for operation on a computer or a stand-alone electronic device which displays test patterns and asks the user to identify any which are blurry. The vision testing monitor 96 can then track any areas of weakness in a person's vision and any changes therein. A hearing monitor 98 can play sounds which the user must acknowledge with the press of a feedback button. A reflex monitor 100 can operate in a similar fashion using a patient feedback response. A memory monitor 102 can be configured by a patient with questions and answers that the patient should know the answer to. The memory monitor 102 can provide the patient with a question and track whether or not the patient remembers the answer over time to look for memory degradation. The exercise monitor 104 can be coupled to a treadmill or other exercise equipment. The breathing monitor 106 can be coupled to a sleep apnea mask or other oxygen delivery system. These are just examples of various embodiments of health objects which can be included in the medical kit 52, and it will be apparent that many other embodiments are possible for each type of health object given as examples. The at least one health object 56 is intended to include any home care monitoring device 112. The at least one health object is also intended to include data collection software 114 which may be coupled to the monitoring devices.

The at least one health object 56 is not limited to monitoring devices. As FIG. 6B schematically illustrates, other embodiments of the at least one health object may include a diet control regime 114, an exercise control regime 116, or any control regime 118 deemed appropriate for the medical kit 52.

As mentioned previously, the medical kit 52 comes with instructions 58 for using the at least one health object 56. The instructions 58 may be written, audio, visual, or any combination thereof. The instructions 58 may be physically included in the medical kit 52 or they may be referenced by provision of a web address, information telephone number, or some other remote access method.

FIG. 7 schematically illustrates another embodiment of a medical kit 120. This medical kit 120 includes at least one education tool 54, at least one health object 56, and instructions 58 for using the at least one health object 56 as discussed above for the embodiment of FIG. 4. However, the embodiment of FIG. 7 also includes a setup and/or training service 122. This set-up and/or training service 122 can include contact information for the patient to make arrangements for someone familiar with the kit to come to the patient for the purpose of tutoring the patient on the use of one or more elements of the medical kit 120 and/or setting-up one or more elements of the medical kit 120. The set-up and/or training can be done remotely for all or part of the training in other embodiments.

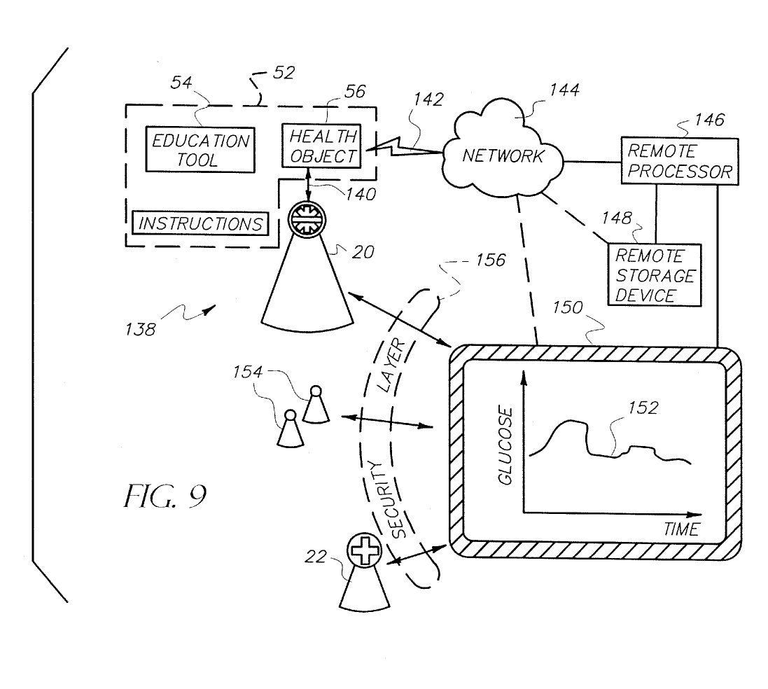

FIG. 8 schematically illustrates one embodiment of a diabetic introductory medical kit 124 which is just one embodiment of the medical kit 52 previously described. This embodiment of the diabetic introductory medical kit 124 has several education tools 54. The education tools 54 of this embodiment include exercise information materials 126, dietary information materials 128, and other information materials 130, such as explanations of what diabetes is, what type of diabetes the patient has, things to watch out for, etc. This embodiment of the diabetic introductory medical kit 124 also has several health objects 56. The health objects 56 of this embodiment include a glucometer with communication capability 132, a supply of test strips and consumables 134, and instrumentation and software 136 which make blood glucose data collected by the glucometer 132 available to others such as physicians, family, friends, and the patient. This embodiment of the diabetic introductory medical kit 124 also has instructions 58 for use of the health objects 56. Other embodiments can have different education tools 54 and/or different health objects 56.

FIG. 9 schematically illustrates one embodiment of a system 138 for increasing a patient's 20 chances of successfully regulating a medical condition. The system 138 includes a medical kit 52. The medical kit 52 includes at least one education tool 54 related to the medical condition and designed to help the patient 20 become a seasoned patient in regard to the medical condition. The medical kit 52 also includes at least one health object 56 which can be used by the patient 20 to collect data 140 about the patient 20 and which is designed to communicate 142 with a network 144. The network 144 may be a local area network (LAN), such as a hard-wired LAN such as, for example, an Ethernet network or a wireless LAN (WLAN), such as a for example a WLAN implemented with an 802.11 protocol or the Bluetooth® protocol. The network 144 may alternatively be a wide area network (WAN) such as the internet or a wireless wide area network (WWAN) such as a GSM or CDMA cellular phone network, or any combination of the types of networks listed or their equivalents. The at least one health object 56 may communicate 142 with the network using wireless magnetic, wireless RF, wireless infrared, fiber optic, conductive wire communications, or any combination or equivalent thereof.

The system 138 also includes a remote processor 146 which is coupled to the network 144. The processor 146 is capable of receiving and/or retrieving the data 140 collected by the health object 56 as communicated via the network 144. The processor 146 may include a microprocessor, a computer, an application specific integrated circuit (ASIC), digital components, analog components, or any combination or quantity thereof. The system 138 also includes a remote storage device 148. The remote storage device 148 may be coupled directly to the remote processor 146 or indirectly to the remote processor 146, for example via the network 144. Remote storage device 148 stores the data 140 retrieved and/or received by the remote processor 146.

In some embodiments, a display 150 may be coupled to the remote processor 146. This coupling may be direct or indirect (for example over a network). In this type of embodiment, the remote processor 146 may be configured to display 152 the data 140 from the health object 56 relative to the patient's medical condition. In the embodiment shown in FIG. 9, the example displayed data 152 is glucose versus time. In other embodiments, other types of data can be collected and displayed, depending on the health object and the medical condition. The displayed data 152 may be viewed by the patient 20, a physician 22, or other people 154 as controlled by a security layer 156 which may be implemented in some embodiments in order to enforce HIPPA medical information privacy guidelines or other privacy concerns. The security layer 156 can involve the need for passwords and/or digital certificates to see the displayed data. This type of system 138 offers convenience for the patient 20 not only in the collection of his medical data, but also in the sharing of it with physicians 22 and other people 154 such as concerned family and friends.

While reference has been made to various embodiments, it should be understood that numerous changes may be made within the spirit and scope of the inventive concepts described. Accordingly, it is intended that the invention not be limited to the described embodiments, but will have full scope defined by the language of the following claims and their equivalents.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. §112.

What is claimed is:

1. A medical kit for educating a patient, comprising:
at least one education tool related to at least one medical condition and designed to help the patient become a seasoned patient in regard to the medical condition;
at least one health object which can be used by the patient; and
instructions for using the at least one health object.

2. The medical kit of claim 1, further comprising a carrying case.

3. The medical kit of claim 1, wherein the at least one education tool comprises information material related to the at least one medical condition.

4. The medical kit of claim 3, wherein the information material is selected from the group consisting of a compact disc, a DVD, a flash drive, a disk, a computer memory, a book, a pamphlet, a chart, a cassette, an internet address, a telecommunication number, an organization, and a table.

5. The medical kit of claim 1, wherein the at least one education tool comprises training material.

6. The medical kit of claim 5, wherein the training material is selected from the group consisting of a training voucher and a setup voucher.

7. The medical kit of claim 1, wherein the at least one education tool comprises exercise information material.

8. The medical kit of claim 1, wherein the at least one education tool comprises dietary information material.

9. The medical kit of claim 1, wherein the at least one education tool comprises information material on communicating with a health care professional.

10. The medical kit of claim 1, wherein the at least one education tool comprises information material on educating family, friends, and/or co-workers of the patient.

11. The medical kit of claim 1, wherein the at least one education tool comprises information material on recognizing and/or analyzing trends related to the at least one medical condition.

12. The medical kit of claim 1, wherein the at least one education tool comprises information material on emergency precautions and procedures.

13. The medical kit of claim 1, wherein the at least one education tool is tailored based on an age of the patient, a mental capacity of the patient, a disability of the patient, or an education level of the patient.

14. The medical kit of claim 1, wherein:
the at least one medical condition comprises diabetes; and
the at least one education tool comprises informative materials on diabetes.

15. The medical kit of claim 1, wherein the at least one medical condition is selected from the group consisting of high blood pressure, heart disease, abnormal pulse, abnormal weight, asthma, pregnancy, need for oxygen, stroke, influenza, pneumonia, kidney disease, liver disease, skin disease, allergies, eye conditions, thyroid disease, lung disease, muscular disease, cancer, the common cold, lupus, and arthritis.

16. The medical kit of claim 1, wherein the at least one health object comprises a home care monitoring device.

17. The medical kit of claim 16, wherein the home care monitoring device comprises a glucose monitor.

18. The medical kit of claim 16, wherein the home care monitoring device is selected from the group consisting of a blood pressure monitor, a heart monitor, a vision testing monitor, a breathing monitor, an exercise monitor, a memory monitor, a reflex monitor, and a hearing monitor.

19. The medical kit of claim 16, wherein the home care monitoring device comprises a connecting device.

20. The medical kit of claim 16, wherein the home care monitoring device comprises a communications portal.

21. The medical kit of claim 1, wherein the at least one health object comprises a control regime.

22. The medical kit of claim 21, wherein the control regime emphasizes diet control for people with diabetes.

23. The medical kit of claim 21, wherein the control regime emphasizes exercise for people with diabetes.

24. The medical kit of claim 1, wherein the at least one health object comprises data collection software.

25. The medical kit of claim 1, wherein the at least one health object comprises:
a glucometer with communication capability;
a test strip supply; and
instrumentation and software to make blood glucose data available to other people.

26. The medical kit of claim 25, wherein:
the instrumentation is configured to be able to couple the glucometer to a network; and
the software is configured to receive the blood glucose data from the glucometer and share it on the network.

27. The medical kit of claim 26, wherein the network is a local area network.

28. The medical kit of claim 27, wherein the network is a wide area network.

29. The medical kit of claim 26, wherein the glucometer communicates with the network wirelessly.

30. A method for increasing a patient's chances of successfully regulating a medical condition, comprising:
establishing the patient is at high risk for or has the medical condition;
providing the patient with a medical kit for educating the patient in regards to the medical condition, the medical kit comprising:
1) at least one education tool related to the medical condition and designed to help the patient become a seasoned patient in regard to the medical condition;
2) at least one health object which can be used by the patient; and
3) instructions for using the at least one health object; and
using the at least one education tool, the health object, and the instructions by the patient to assist the patient in becoming a seasoned patient.

31. The method of claim 30, further comprising:
selecting the at least one education tool, the at least one health object, and the instructions by an entity other than a physician who is treating the patient, wherein the physician provides the medical kit to the patient.

32. The method of claim 30, further comprising:
selecting the at least one education tool, the at least one health object, and the instructions by a physician who is treating the patient.

33. The method of claim 30, further comprising selecting the medical kit based on a patient parameter.

34. The method of claim 33, wherein the patient parameter is selected from the group consisting of:
a) an age of the patient;
b) health of the patient;
c) habits of the patient;
d) an education level of the patient;
e) computer skills of the patient;
f) whether or not the patient has access to a phone line;
g) whether or not the patient has internet access;
h) a language of the patient;
i) a mental capacity of the patient; and
j) a physical capacity of the patient.

35. The method of claim 30, wherein the at least one health object comprises a monitoring device.

36. The method of claim 33, wherein the at least one health object also comprises a communication device.

37. The method of claim 34, further comprising:
using the monitoring device by the patient to gather data from the patient related to the medical condition; and
communicating the data over a network.

38. The method of claim 37, wherein communicating the data over a network comprises communicating the data to a medical facility.

39. The method of claim 30, further comprising setting up the at least one health object for the patient.

40. The method of claim 30, further comprising training the patient on how to use the at least one health object.

41. A system for increasing a patient's chances of successfully regulating a medical condition, comprising:
a) a medical kit for educating the patient in regard to the medical condition, the medical kit comprising:
1) at least one education tool related to the medical condition and designed to help the patient become a seasoned patient in regard to the medical condition;
2) at least one health object which can be used by the patient to collect data about the patient and which is configured to communicate with a network; and
3) instructions for using the at least one health object; and
b) a remote processor which is coupled to the network;
c) a remote storage device coupled to the remote processor; and
d) wherein the at least one health object may communicate data about the patient relative to the medical condition over the network to the remote processor for storage in the remote storage device.

42. The system of claim 41, further comprising a display coupled to the remote processor, wherein the remote processor is further configured to display data, from the at least one health object, about the patient relative to the medical condition on the display.

43. The system of claim 42, further comprising a security layer which controls when the display may display the data.
